(19) United States
(12) Patent Application Publication
(10) Pub. No.: US 2026/0129631 A1
(43) Pub. Date: May 7, 2026

(54) DISTRIBUTED RU IMPROVEMENTS

(71) Applicant: MaxLinear, Inc., Carlsbad, CA (US)

(72) Inventors: Rainer Strobel, München (DE); Avi Avraham Mansour, Givat-Shmuel (IL); Ziv Avital, Kadima (IL); Sigurd Schelstraete, Menlo Park, CA (US)

(73) Assignee: MaxLinear, Inc., Carlsbad, CA (US)

(21) Appl. No.: 19/382,171

(22) Filed: Nov. 6, 2025

Related U.S. Application Data
(60) Provisional application No. 63/717,277, filed on Nov. 6, 2024.

(51) Int. Cl. H04W 72/044; H04B 1/38; H04L 25/02

(52) U.S. Cl. CPC H04W 72/046; H04B 1/38; H04L 25/0202

(57) ABSTRACT

An access point may include a transceiver and a processing device. The transceiver may be operable to communicate with at least on station. The processing device may be operable to determine distributed resource units for the station to use for transmissions with the access point. The processing device may also be operable to estimate a channel between the access point and the at least one station. The processing device may further be operable to determine beamforming coefficients based on the estimated channel. The processing device may also be operable to transmit the beamforming coefficients and an uplink data frame to the at least one station. The processing device may further be operable to obtain a beamforming-triggered distributed resource unit transmission from the at least one station.

### CROSS REFERENCE TO RELATED APPLICATIONS

This U.S. Patent Application claims priority to U.S. Provisional Patent Application No. 63/717,277, titled “DISTRIBUTED RU IMPROVEMENTS,” and filed on November 6, 2024, the disclosure of which is hereby incorporated by reference in its entirety.

### TECHNICAL FIELD

This disclosure generally relates to wireless communication, and more specifically, to distributed resource unit improvements.

### BACKGROUND

Unless otherwise indicated herein, the materials described herein are not prior art to the claims in the present application and are not admitted to be prior art by inclusion in this section.

Institute of Electrical and Electronics Engineers (IEEE) 802.x standards include protocols for implementing various networking techniques, including wireless local area network (WLAN) communications and Wi-Fi. Ultra High Reliability (UHR) is a WLAN capability that aims to improve the reliability of WLAN connectivity. UHR is being developed by the IEEE 802.11 working group, and will form the basis of Wi-Fi 8.

The subject matter claimed in the present disclosure is not limited to implementations that solve any disadvantages or that operate only in environments such as those described above. Rather, this background is only provided to illustrate one example technology area where some implementations described in the present disclosure may be practiced.

### SUMMARY

In an example embodiment, an access point (AP) may include a transceiver and a processing device. The transceiver may be operable to communicate with at least on station (STA). The processing device may be operable to determine distributed resource units for the STA to use for transmissions with the AP. The processing device may also be operable to estimate a channel between the AP and the at least one STA. The processing device may further be operable to determine beamforming coefficients based on the estimated channel. The processing device may also be operable to transmit the beamforming coefficients and an uplink data frame to the at least one STA. The processing device may further be operable to obtain a beamforming-triggered distributed resource unit transmission from the at least one STA.

In another embodiment, a method may include determining a modulation and coding scheme used by a transmitter in a wireless local area network (WLAN). The method may also include distributing a subset of available carriers to the transmitter as part of a tone plan in response to a distortion limit based on the modulation and coding scheme. The method may further include transmitting, by the transmitter, data in the WLAN using the subset of available carriers and according to the tone plan.

In another embodiment, a method may include transmitting a sounding trigger frame to at least one STA using a channel. The method may also include obtaining a sounding response from the at least one STA. The method may further include estimating the channel. The method may also include determining beamforming coefficients based on the estimated channel. The method may further include transmitting the beamforming coefficients and an uplink data frame to the at least one STA. The method may also include obtaining a beamforming-triggered distributed resource unit transmission from the at least one STA.

The objects and advantages of the embodiments will be realized and achieved at least by the elements, features, and combinations particularly pointed out in the claims.

Both the foregoing general description and the following detailed description are given as examples and are explanatory and not restrictive of the invention, as claimed.

### DESCRIPTION OF DRAWINGS

Example implementations will be described and explained with additional specificity and detail using the accompanying drawings in which:

FIG. 1 illustrates a block diagram of an example system for distributed resource unit improvements;

FIG. 2 illustrates a block diagram of an example modulation and coding scheme and an associated transmit error vector magnitude;

FIG. 3 illustrates a flowchart of an example method for transmitter distortion optimized tone plans;

FIG. 4 illustrates a flowchart of an example method for uplink beamforming in a wireless local area network; and

FIG. 5 illustrates an example computing device.

### DETAILED DESCRIPTION

A distributed resource unit (DRU) for uplink orthogonal frequency-division multiple access (UL-OFDMA) may be a feature to improve range extension in a wireless local area network, such as the IEEE 802.11bn standard. In such instances, the uplink transmit signal may be spread over a wide bandwidth which may contribute to overcoming power spectral density (PSD) mask limitations, which may be provided by regulation including in the 6GHz band. In some instances, multiple uplink transmissions may be interleaved in frequency to avoid a loss of spectral efficiency. The system and methods described herein may contribute to an efficient operation of DRU UL-OFDMA by addressing transmitter distortion optimized tone plans, uplink power control, and/or uplink beamforming.

In some prior approaches, some 802.11 WLAN systems may use regular resource units (RRUs) for UL-OFDMA, where each STA may transmit on a continuous portion of available bandwidth. In some instances, small guard bands between the RRUs may be used and in instances in which there is interference due to nonlinear distortion, the interference may primarily affect neighboring RUs.

Some proposed solutions may include various tone plan proposals, which may be optimized for peak-to-average power ratio (PAPR) and/or clock recovery. However, performance differences between individual tone plans may be minor. Alternatively, nonlinear distortion may cause a greater performance degradation, especially in instances in which the tone plan is poorly designed.

In a DRU transmission, multiple wireless local area network (WLAN) stations (STAs) may be operable to transmit to an access point (AP) using different tone sets. In some instances, individual STA tones may be spread over a wide bandwidth. Such an arrangement may facilitate overcoming PSD limitations, including those that may be present in the 6GHz band. Alternatively, or additionally, there may be no guard band between the transmission bands of the different STAs and nonlinear distortion may have an impact on other resource units. In some instances, distortion optimized tone plans may be used to minimize negative impacts of transmitter nonlinear distortion. Transmit beamforming in combination with DRU transmission, as described herein, may provide improvements to the range of any particular STA, including STAs having two or more antennas.

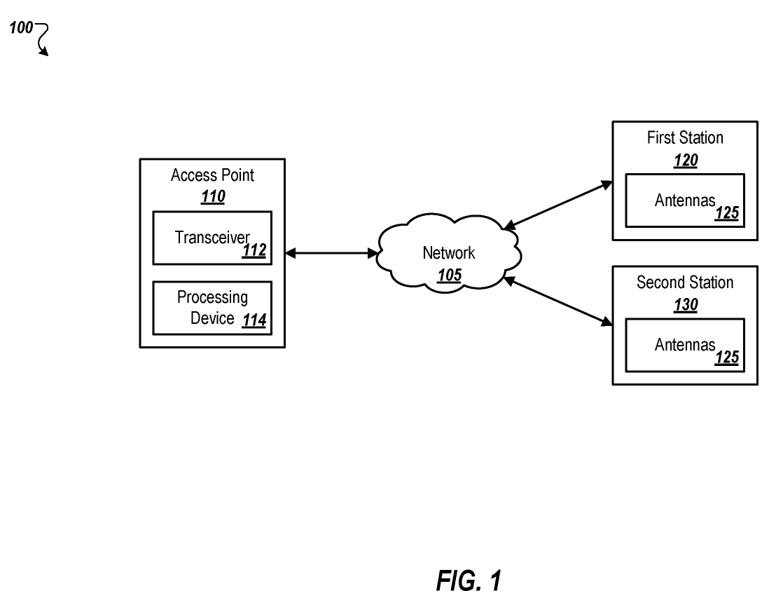

FIG. 1 illustrates a block diagram of an example system 100 for distributed resource unit improvements. The system 100 may include a network 105, an access point (AP) 110, a first station (STA) 120, and a second STA 130. The AP 110 may include a transceiver 112 and a processing device 114. The first STA 120 may include antennas 125 and the second STA 120 may include antennas 125.

In some instances, the AP 110 may be operable to enable beamforming-triggered DRU transmissions in the network 105, where the network 105 may be a WLAN. The transceiver 112 may be operable to communicate with at least the first STA 120 and/or the second STA 130, using a channel supported by the network 105. The transceiver 112 may support uplink and/or downlink OFDMA and/or may be capable of transmitting trigger frames, sounding requests, and/or beamforming feedback messages, as described herein. The AP 110 may be operable to implement uplink power control, tone plan selection that may be based on a modulation and coding scheme (MCS), and/or dynamic adjustment of long training field (LTF) sequence length based on the number of the antennas 125 associated with the first STA 120 and/or the second STA 130, as described herein.

The processing device 114 may be operable to determine DRUs for the first STA 120 and/or the second STA 130 (and/or other STAs included in the system 100 and connected to the AP 110 via the network 105) that may be participating in an uplink transmission. The DRUs may include a subset of carriers that may be arranged on a regular tone grid, where a spacing between the carriers may be an integer multiple of a spreading factor. In some instances, the tone plan may be distortion-optimized such that third-order intermodulation distortion products (e.g., frequencies f₁ and f₂ may cause distortion at frequencies 2 f₁ - f₂ and2 f₂ - f₁) may fall on carriers with the same DRU and/or on unused carriers, which may result in reducing interference across the resource units, including instances in which the first STA 120 and the second STA 130 may be transmitting simultaneously without using guard bands.

In some instances, the DRUs may be a non-contiguous grouping of OFDMA carriers within a WLAN channel that may be assigned to an individual STA (e.g., the first STA 120 and/or the second STA 130) for uplink transmission to the AP 110. Unlike regular resource units (RRUs), the DRUs may interleave carriers associated with the first STA 120 with carriers associated with the second STA 130 in the same uplink OFDMA transmission. In some instances, the DRUs may be generated from a regular tone grid that may include a spreading factor S, such that the carriers of a DRU may occupy tone indices k, k+S, k+2S, … over the system bandwidth. In some instances, the AP 110 may exclude DC carriers and/or band-edge carriers from the regular tone grid. Alternatively, or additionally, additional DRUs for other STAs may be formed by cyclic shifts of the regular tone grid using offsets smaller than S (e.g., shifts of 1, 2, or 3 when S = 4), which may enable multiple interleaved DRUs that maximize spectral reuse while accommodating regulatory power spectral density (PSD) constraints, such as those applicable in the 6 GHz band. Such an arrangement may provide a framework in which multiple STAs may concurrently transmit over a shared frequency span while maintaining orthogonality in the frequency domain at the OFDMA symbol rate.

In an example, given a spreading factor S = 4, a first DRU may occupy tone indices (1, 5, 9, …), a second DRU may occupy tone indicies (2, 6, 10, …), a third DRU may occupy tone indicies (3, 7, 11, …), and a fourth DRU may occupy tone indices (4, 8, 12, …). Alternatively, or additionally, the DC carriers and/or the band-edge carriers may be exclude from the DRUs. In some instances, the DRU carriers at frequencies f₁ and f₂ may cause a distortion at frequencies 2 f₁ - f₂ and2 f₂ - f₁. As such, the tones may be selected such that 2 f₁ - f₂ and2 f₂ - f₁ generated by any pair of active tones within a given DRU may land on tones that may be assigned to the same DRU and/or may be left unused.

The processing device 114 may be operable to perform a channel estimation of the channel that may be used in the network 105. The AP 110 may transmit a sounding trigger frame that may initiate channel sounding. In response, the first STA 120 and/or the second STA 130 may transmit a null data packet (NDP) that may include LTF symbols. The LTF symbols may be modulated with orthogonal codes that may be individually unique to the first STA 120 and/or the second STA 130. Alternatively, or additionally, the LTF symbols may be transmitted using the carriers of the assigned DRU, which may allow the AP 110 to separate signals from the first STA 120 and the second STA 130 and/or allow the AP 110 to estimate the uplink channel.

In some instances, the AP 110 may initiate a channel estimation by transmitting the sounding trigger frame to at least the first STA 120 and/or the second STA 130. In response, the STAs may transmit NDPs that may include the LTF symbols. In some instances, the sounding response from the STAs may be realized using various modes of operation. The first may be a frequency-domain separation where each STA may transmit the LTF symbols using carriers belonging to the STAs assigned DRU. Such an arrangement may allow the AP 110 to separate the transmissions without using long, orthogonal sequences. The second may be a code-domain separation where each STA may transmit the LTF symbols across the full channel bandwidth while applying mutually orthogonal code to the training symbols. The third may be time-domain separation where the AP 110 may schedule NDPs from the first STA 120 at a first time and NDPs from the second STA 130 at a second time, and/or optionally spanning the full channel bandwidth. In these and other instances, the AP 110 may select among the modes of operations (including combinations thereof) dynamically, and may make a selection based on a load of the network 105, capabilities of the STAs (e.g., number of antenna), and/or a target latency.

In some instances, the sounding trigger frame may be adapted based on the antennas 125 in each of the STAs. For example, a sequence length and/or structure of the LTF may be based on a number of the antennas 125 at each STA, and/or an aggregate number of antennas 125 in each of the STAs. For frequency-separated DRU sounding, the AP 110 may select an LTF length that may correspond with the maximum number of antennas per STA, as the frequency isolation may reduce a need for long LTF sequences. In some instances, the AP 110 may determine the LTF sequence length for a particular STA (e.g., the first STA 120) based on a maximum number of the antennas 125 associated with the particular STA. Alternatively, or additionally, a longer LTF sequence may be used that may correspond to a sum total of the antennas 125 of each of the STAs in the system 100, such that the AP 110 may obtain a full channel knowledge and may be operable to assign the tone plans in view of the full channel knowledge.

Based on the estimated channel, the processing device 114 may be operable to compute beamforming coefficients for the first STA 120 and/or the second STA 130. The beamforming coefficients may be transmitted back to the corresponding STA in a downlink OFDMA or a multi-user-multiple input multiple output (MU-MIMO) frame. Alternatively, or additionally, an uplink data frame may be transmitted from the AP 110 to the first STA 120 and/or the second STA 130 that may be used to schedule the beamforming-triggered distributed resource unit transmission. In some instances, the uplink data frame may include at least DRU allocations, modulation and coding scheme (MCS), and/or timing for the scheduled uplink.

In some instances, upon obtaining the beamforming coefficients and/or the uplink data frame, the first STA 120 and/or the second STA 130 may apply the beamforming coefficients to the respective transmission over the assigned DRUs. In some instances, each STA may be operable to transmit across the full channel bandwidth by using an orthogonal code that may be distinct from other orthogonal codes that may be used by other STAs. Alternatively, or additionally, each STA may be operable to transmit using the corresponding carriers of the assigned DRU. In such instances, the system 100 may support beamforming gain and/or range extension that may maintain compliance with PSD limits in a frequency band, such as the 6GHz band.

Modifications, additions, or omissions may be made to the system 100 without departing from the scope of the present disclosure. For example, the designations of different elements in the manner described is meant to help explain concepts described herein and is not limiting. Further, the system 100 may include any number of other elements or may be implemented within other systems or contexts than those described. For example, any of the components of FIG. 1 may be divided into additional or combined into fewer components.

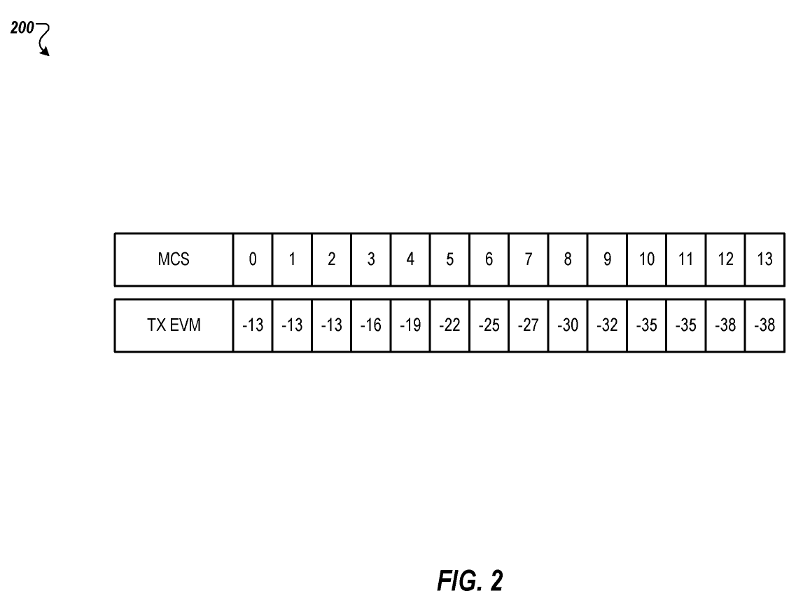

FIG. 2 illustrates a block diagram 200 of an example modulation and coding scheme (MCS) and an associated transmit (TX) error vector magnitude (EVM). In some instances, an AP may determine a distribution of resource units for a particular STA, as described herein. In such instances, the DRUs may be based on the MCS associated with the particular STA. The block diagram 200 illustrates a mapping of the MCS indices to corresponding TX EVM limits.

In some prior approaches, an unused tone error in a neighbor RU should be 2dB below the in-band TX EVM value and 10dB below the in-band TX EVM for more distant RUs. In some instances, nonlinear distortion may be primarily IP3 (third-order intermodulation) distortion. The nonlinear distortion may cause degradations in transmissions without spacing, such as according to a tone plan as described herein.

The AP may be operable to determine the tone plan for the DRUs to minimize the distortion impact across multiple STAs. In some instances, the tone plan may be based on a regular tone grid, where each carrier in the DRU may be spaced by an integer multiple of a spreading factor. Such an arrangement may cause the third-order intermodulation distortion to fall on carriers within the same DRU and/or on unused carriers, which may reduce or remove interference with other DRUs. For example, the DRU carriers at frequencies f₁ and f₂ may cause distortion at frequencies 2 f₁ - f₂ and2 f₂ - f₁. In some instances, not all tones of the regular tone grid may be used, such as the DC carriers and/or the band-edge carriers.

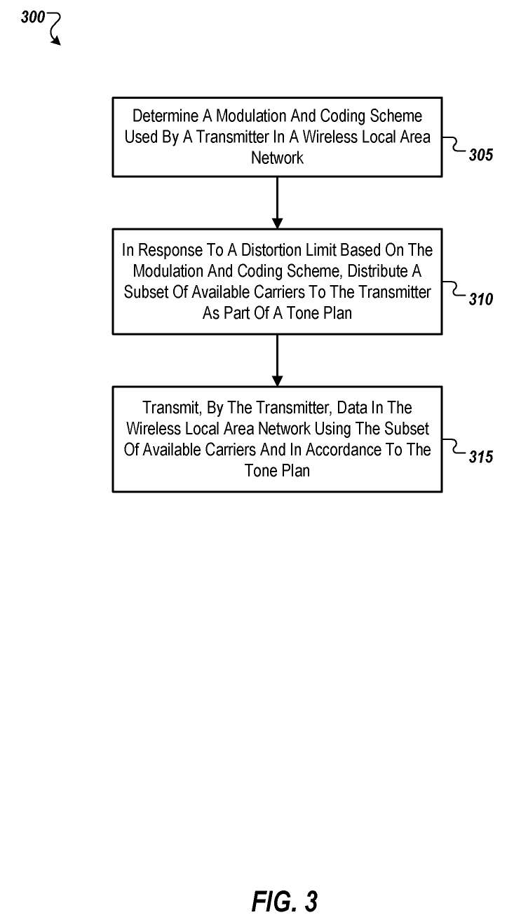

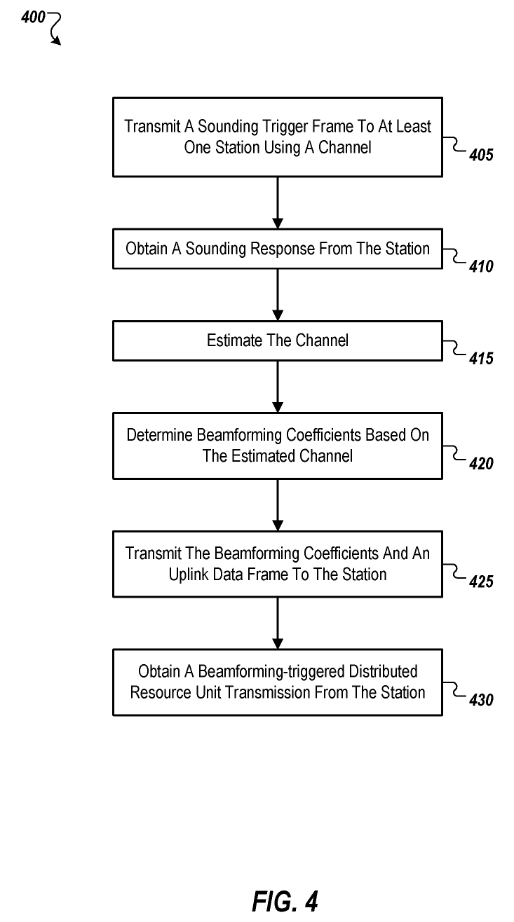

FIG. 3 illustrates a flowchart of an example method 300 for transmitter distortion optimized tone plans. FIG. 4 illustrates a flowchart of an example method 400 for uplink beamforming in a wireless local area network. The methods 300 and 400 may be performed by processing logic that may include hardware (circuitry, dedicated logic, etc.), software (such as is run on a general purpose computer system or a dedicated machine), or a combination of both, which processing logic may be included in any computer system or device such as the AP 110 of FIG. 1.

For simplicity of explanation, methods described herein are depicted and described as a series of acts. However, acts in accordance with this disclosure may occur in various orders and/or concurrently, and with other acts not presented and described herein. Further, not all illustrated acts may be used to implement the methods in accordance with the disclosed subject matter. In addition, those skilled in the art will understand and appreciate that the methods may alternatively be represented as a series of interrelated states via a state diagram or events. Additionally, the methods disclosed in this specification may be capable of being stored on an article of manufacture, such as a non-transitory computer-readable medium, to facilitate transporting and transferring such methods to computing devices. The term article of manufacture, as used herein, is intended to encompass a computer program accessible from any computer-readable device or storage media. Although illustrated as discrete blocks, various blocks may be divided into additional blocks, combined into fewer blocks, or eliminated, depending on the desired implementation.

The method 300 may begin at block 305 where a modulation and coding scheme used by a transmitter in a WLAN may be determined.

At block 310, a subset of available carriers may be distributed to the transmitter as part of a tone plan. In some instances, the distribution of the subset of available carriers may be in response to a distortion limit based on the modulation and coding scheme. In some instances, the tone plan may be constructed on a regular tone grid such that each carrier in the subset of available carriers may be spaced by an integer multiple of a spreading factor. In some instances, the subset of available carriers may exclude DC carriers and/or band-edge carriers. In instances in which a particular carrier is not used, the particular carrier may not be included in the regular tone grid. In such instances, the particular carrier may be at least one of a DC carrier or an edge-band carrier.

In some instances, the tone plan may be distortion optimized such that gaps may exist in a distortion spectrum based on the distribution of the subset of available carriers. In some instances, the tone plan may be arranged such that distortion associated with a second resource unit may not be caused by distortion associated with a first resource unit. Alternatively, or additionally, the first resource unit and the second resource unit may use the same transmit spectrum.

At block 315, data in the WLAN may be transmitted by the transmitter using the subset of available carriers and according to the tone plan.

Modifications, additions, or omissions may be made to the method 300 without departing from the scope of the present disclosure. For example, the designations of different elements in the manner described is meant to help explain concepts described herein and is not limiting. Further, the method 300 may include any number of other elements or may be implemented within other systems or contexts than those described.

The method 400 may begin at block 405 where a sounding trigger frame may be transmitted to at least one STA using a channel.

At block 410, a sounding response may be obtained from the STA. In some instances, the sounding response may include NDPs from the STA. In some instances, each NDP may include LTF symbols for channel estimation. In some instances, the LTF symbols may be orthogonal frequency division multiplexed symbols and may be modulated with an orthogonal code that may differ for each transmit antenna. Alternatively, or additionally, a length of the LTF symbols may be determined based on a number of antennas associated with the STA. In some instances, the sounding response from the STA may include a first NDP at a first time and a second sounding response from a second STA may include a second NDP at a second time.

At block 415, the channel may be estimated.

At block 420, beamforming coefficients may be determined based on the estimated channel.

At block 425, the beamforming coefficients and an uplink data frame may be transmitted to the STA.

At block 430, a beamforming-triggered DRU transmission may be obtained from the STA. In some instances, the beamforming-triggered DRU transmission may be obtained from the STA using carriers of a subset of DRUs. Alternatively, or additionally, the beamforming-triggered DRU transmission may be obtained from the STA using a full bandwidth of the channel. The beamforming-triggered DRU transmission from the STA may include an orthogonal code that may differ from a beamforming transmission from a second STA.

Modifications, additions, or omissions may be made to the method 400 without departing from the scope of the present disclosure. For example, the designations of different elements in the manner described is meant to help explain concepts described herein and is not limiting. Further, the method 400 may include any number of other elements or may be implemented within other systems or contexts than those described.

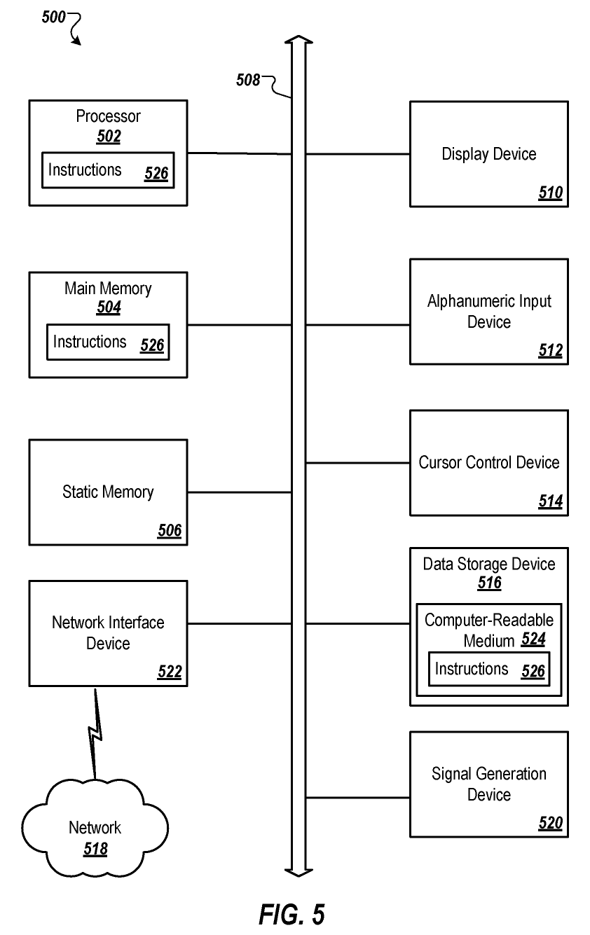

FIG. 5 illustrates an example computing device 500 within which a set of instructions, for causing the machine to perform any one or more of the methods discussed herein, may be executed. The computing device 500 may include a mobile phone, a smart phone, a netbook computer, a rackmount server, a router computer, a server computer, a personal computer, a mainframe computer, a laptop computer, a tablet computer, a desktop computer, or any computing device with at least one processor, etc., within which a set of instructions, for causing the machine to perform any one or more of the methods discussed herein, may be executed. In alternative implementations, the machine may be connected (e.g., networked) to other machines in a LAN, an intranet, an extranet, or the Internet. The machine may operate in the capacity of a server machine in client-server network environment. The machine may include a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” may also include any collection of machines that individually or jointly execute a set (or multiple sets) of instructions to perform any one or more of the methods discussed herein.

The computing device 500 includes a processing device 502 (e.g., a processor), a main memory 504 (e.g., read-only memory (ROM), flash memory, dynamic random access memory (DRAM) such as synchronous DRAM (SDRAM)), a static memory 506 (e.g., flash memory, static random access memory (SRAM)) and a data storage device 516, which communicate with each other via a bus 508.

The processing device 502 represents one or more general-purpose processing devices such as a microprocessor, central processing unit, or the like. More particularly, the processing device 502 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 502 may also include one or more special-purpose processing devices such as an application specific integrated circuit (ASIC), a field programmable gate array (FPGA), a digital signal processor (DSP), network processor, or the like. The processing device 502 is configured to execute instructions 526 for performing the operations and steps discussed herein.

The computing device 500 may further include a network interface device 522 which may communicate with a network 518. The computing device 500 also may include a display device 510 (e.g., a liquid crystal display (LCD) or a cathode ray tube (CRT)), an alphanumeric input device 512 (e.g., a keyboard), a cursor control device 514 (e.g., a mouse) and a signal generation device 520 (e.g., a speaker). In at least one implementation, the display device 510, the alphanumeric input device 512, and the cursor control device 514 may be combined into a single component or device (e.g., an LCD touch screen).

The data storage device 516 may include a computer-readable storage medium 524 on which is stored one or more sets of instructions 526 embodying any one or more of the methods or functions described herein. The instructions 526 may also reside, completely or at least partially, within the main memory 504 and/or within the processing device 502 during execution thereof by the computing device 500, the main memory 504 and the processing device 502 also constituting computer-readable media. The instructions may further be transmitted or received over the network 518 via the network interface device 522.

While the computer-readable storage medium 524 is shown in an example implementation to be a single medium, the term “computer-readable storage medium” may include a single medium or multiple media (e.g., a centralized or distributed database and/or associated caches and servers) that store the one or more sets of instructions. The term “computer-readable storage medium” may also include any medium that is capable of storing, encoding or carrying a set of instructions for execution by the machine and that cause the machine to perform any one or more of the methods of the present disclosure. The term “computer-readable storage medium” may accordingly be taken to include, but not be limited to, solid-state memories, optical media and magnetic media.

Terms used in the present disclosure and especially in the appended claims (e.g., bodies of the appended claims) are generally intended as “open terms” (e.g., the term “including” should be interpreted as “including, but not limited to.”).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is expressly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase preceding two or more alternative terms, whether in the description, claims, or drawings, should be understood to contemplate the possibilities of including one of the terms, either of the terms, or both of the terms. For example, the phrase “A or B” should be understood to include the possibilities of “A” or “B” or “A and B.”

All examples and conditional language recited in the present disclosure are intended for pedagogical objects to aid the reader in understanding the present disclosure and the concepts contributed by the inventor to furthering the art, and are to be construed as being without limitation to such specifically recited examples and conditions. Although implementations of the present disclosure have been described in detail, various changes, substitutions, and alterations could be made hereto without departing from the spirit and scope of the present disclosure.

What is claimed is:

1. An access point (AP), comprising:
a transceiver operable to communicate with at least one station (STA);
a processing device operable to;
determine distributed resource units for the at least one STA to use for transmissions with the AP;
estimate a channel between the AP and the at least one STA;
determine beamforming coefficients based on the estimated channel;
transmit the beamforming coefficients and an uplink data frame to the at least one STA; and
obtain a beamforming-triggered distributed resource unit transmission from the at least one STA.

2. The AP of claim 1, wherein the distributed resource units are based on a modulation and coding scheme used by the at least one STA in a wireless local area network.

3. The AP of claim 1, wherein the distributed resource units are assigned in accordance with a tone plan that is constructed on a regular tone grid such that each carrier in a subset of available carriers is spaced by an integer multiple of a spreading factor.

4. The AP of claim 3, wherein the tone plan is distortion optimized such that gaps exist in a distortion spectrum, or a third order intermodulation distortion, based on a distribution of a subset of available carriers.

5. The AP of claim 1, wherein the processing device estimates the channel based on a sounding response obtained from the at least one STA, and the sounding response comprises null data packets (NDPs) from the at least one STA, each NDP including long training field (LTF) symbols for channel estimation.

6. The AP of claim 1, wherein the beamforming-triggered distributed resource unit transmission is obtained from the at least one STA using a full bandwidth of the channel, and the beamforming-triggered distributed resource unit transmission from the at least one STA comprises an orthogonal code that differs from a beamforming transmission from a second STA.

7. A method, comprising:
determining a modulation and coding scheme used by a transmitter in a wireless local area network (WLAN);
in response to a distortion limit based on the modulation and coding scheme, distributing a subset of available carriers to the transmitter as part of a tone plan; and
transmitting, by the transmitter, data in the WLAN using the subset of available carriers and according to the tone plan.

8. The method of claim 7, wherein the tone plan is constructed on a regular tone grid such that each carrier in the subset of available carriers is spaced by an integer multiple of a spreading factor.

9. The method of claim 8, wherein a particular carrier that is not used is not included in the regular tone grid.

10. The method of claim 9, wherein the particular carrier is at least one of a DC carrier or an edge-band carrier.

11. The method of claim 7, wherein the tone plan is distortion optimized such that gaps exist in a distortion spectrum, or a third order intermodulation distortion, based on the distribution of the subset of available carriers.

12. The method of claim 7, wherein the tone plan is arranged such that distortion associated with a second resource unit is not caused by distortion associated with a first resource unit, and where first resource unit and the second resource unit use the same transmit spectrum.

13. The method of claim 7, wherein the subset of available carriers excludes DC carriers and band-edge carriers.

14. A method, comprising:
transmitting a sounding trigger frame to at least one station (STA) using a channel;
obtaining a sounding response from the at least one STA;
estimating the channel;
determining beamforming coefficients based on the estimated channel;
transmitting the beamforming coefficients and an uplink data frame to the at least one STA; and
obtaining a beamforming-triggered distributed resource unit transmission from the at least one STA.

15. The method of claim 14, wherein the sounding response comprises null data packets (NDPs) from the at least one STA, each NDP including long training field (LTF) symbols for channel estimation.

16. The method of claim 15, wherein the LTF symbols are orthogonal frequency division multiplexed symbols and are modulated with an orthogonal code that differs for each transmit antenna.

17. The method of claim 15, wherein a length of the LTF symbols is determined based on a number of antennas associated with the at least one STA.

18. The method of claim 14, wherein the beamforming-triggered distributed resource unit transmission is obtained from the at least one STA using carriers of a subset of distributed resource units.

19. The method of claim 14, wherein the beamforming-triggered distributed resource unit transmission is obtained from the at least one STA using a full bandwidth of the channel, and the beamforming-triggered distributed resource unit transmission from the at least one STA comprises an orthogonal code that differs from a beamforming transmission from a second STA.

20. The method of claim 14, wherein the sounding response from the at least one STA comprises a first NDP at a first time and a second sounding response from a second STA comprises a second NDP at a second time.
